(19) United States
(12) Patent Application Publication
(10) Pub. No.: US 2026/0006442 A1
(43) Pub. Date: Jan. 1, 2026

(54) Vehicle and Vehicle Network Security Method

(71) Applicants: Hyundai Motor Company, Seoul (KR); Kia Corporation, Seoul (KR)

(72) Inventors: Jin Shun Li, Shandong (CN); Kyong Ho Shon, Hwaseong-Si (KR); Xi Sha Li, Shandong (CN); In Sik Chun, Hwaseong-Si (KR); Hang Hang Wang, Shandong (CN)

(21) Appl. No.: 18/975,250

(22) Filed: Dec. 10, 2024

(30) Foreign Application Priority Data
Jun. 26, 2024 (KR) 10-2024-0083330

(51) Int. Cl. H04W 12/069; H04L 9/08

(52) U.S. Cl. CPC H04W 12/069; H04L 9/0869; H04L 2209/84

(57) ABSTRACT

A vehicle includes a first controller that requests a first authentication process by transmitting a previously stored first shared key ID, and a second controller that verifies validity of a shared key ID by comparing a previously stored second shared key ID with the first shared key ID according to the request for the first authentication process, and performs the first authentication process using the shared key ID of which validity has been verified, in which, when an identity is authenticated through the first authentication process, the first controller increments a value of the first shared key ID by a preset value and stores the value of the first shared key ID and the second controller increments a value of the second shared key ID by the preset value and stores the value of the second shared key ID.

### CROSS-REFERENCE TO RELATED APPLICATION

The present application claims priority Korean Patent Application No. 10-2024-0083330, filed Jun. 26, 2024, the entire contents of which are incorporated herein by reference for all purposes.

### TECHNICAL FIELD

The present disclosure relates to a vehicle and vehicle network security method.

### BACKGROUND

Vehicles may be important assets for customers. For example, due to the electrification of vehicles for things such as convenience functions, safety devices, and infotainment, the roles of electronic devices such as electronic control units (ECUs) have been diversifying and the amounts of data to be protected have been increasing.

For example, with the development of information technology, customers' vehicles may be threatened in a cyber security area, and methods of stealing vehicles through hacking may be developing.

Pre-shared key (PSK) technology is widely used in vehicle authentication as an important security means in authentication of vehicle networks. The PSK technology uses any random number as a shared key ID. If a situation occurs in which a pre-shared key is cracked, an untrusted third-party communication device may perform authentication using a key derived from the pre-shared key. There may be problems that security cannot be maintained, such as if a third-party communication device that performs hacking successfully controls a vehicle, collects key data of the vehicle, transmits a software program package containing a virus to an electronic control unit within the vehicle or the like.

### SUMMARY

The present invention is directed to providing a vehicle and vehicle network security method capable of enhancing security of a pre-shared key ID.

A vehicle may comprise: a first controller configured to initiate a first authentication process by transmitting a previously stored first shared key identity (ID); and a second controller configured to: receive, from the first controller, a request for performing the first authentication process and the previously stored first shared key ID; verify, based on the request, validity of the previously stored first shared key ID by comparing a previously stored second shared key ID with the previously stored first shared key ID, and perform, using the previously stored first shared key ID of which validity has been verified, the first authentication process, wherein, based on an identity associated with the first authentication process being authenticated via the first authentication process; the first controller is configured to: increment a value of the previously stored first shared key ID by a preset value to determine an updated first shared key ID; and store at least one of the incremented value of the previously stored first shared key ID or the updated first shared key ID, and the second controller is configured to: increment a value of the previously stored second shared key ID by the preset value to determine an updated second shared key ID; and store at least one of the incremented value of the previously stored second shared key ID or the updated second shared key ID. The first authentication process and/or the second authentication process may comprise validation of the shared key ID and the process of decrypting and verifying a message encrypted with at least one encryption parameter including the shared key ID. The first authentication process request may be sent from the first controller to the second controller, and the second controller may verify the validity of the first shared key ID. After the validity of the first shared key ID is verified, the second controller may proceed with the first authentication process.

Based on a second authentication process being initiated, the second controller may be configured to perform the second authentication process using the updated first shared key ID and the updated second shared key ID. The second authentication process may be performed after the first authentication process and may use the updated first shared key ID and/or the incremented value.

The first controller may be configured to initiate the second authentication process by transmitting the updated first shared key ID to the second controller. The second controller may be configured to: receive, from the first controller, a second request for performing the second authentication process and the updated first shared key ID; and verify, based on the second request, validity of the updated first shared key ID by comparing the updated second shared key ID with the updated first shared key ID.

Each of the first controller and the second controller may be configured to receive, from a diagnostic device, a random shared key ID generated and store the random shared key ID as an initial shared key ID for the first controller and the second controller, respectively. The preset value may correspond to one.

Based on the validity of the previously stored first shared key ID has been verified, the second controller may be configured to generate a random number and transmit the random number to the first controller.

The first controller may be configured to: verify, using the random number received from the second controller, the previously stored first shared key ID; and based on the verification of the previously stored first shared key ID being successful, generate an encrypted message and transmit the encrypted message to the second controller.

Based on a difference between the value of the previously stored second shared key ID and the value of the previously stored first shared key ID being less than a reference value, the second controller may be configured to: determine that the validity of the previously stored first shared key ID has been verified, and update and store the value of the previously stored second shared key ID using the value of the previously stored first shared key ID.

Based on a difference between the value of the previously stored second shared key ID and the value of the previously stored first shared key ID being greater than or equal to a reference value, the second controller may be configured to determine that the validity of the previously stored first shared key ID has not been verified and output a verification error signal.

Based on a determination that authentication of the identity consecutively fails for a preset number of times or more during a preset time period, the second controller may be configured to activate a protection mode and stop a key authentication process.

Based on receiving a protection mode release signal from a diagnostic device, the second controller may be configured to determine whether a digital key is located inside the vehicle and release the protection mode.

A method performed by a vehicle may comprise: initiating, by a first controller of the vehicle, a first authentication process by transmitting a previously stored first shared key identity (ID); receiving, by a second controller of the vehicle from the first controller, a request for performing the first authentication process and the previously stored first shared key ID; based on the request, verifying, by the second controller, validity of the previously stored first shared key ID by comparing a previously stored second shared key ID with the previously stored first shared key ID; using the previously stored first shared key ID of which validity has been verified, performing, by the first controller and the second controller, the first authentication process; and based on an identity associated with the first authentication process being authenticated via the first authentication process: incrementing, by the first controller, a value of the previously stored first shared key ID by a preset value to determine an updated first shared key ID; storing, by the first controller, at least one of the incremented value of the previously stored first shared key ID or the updated first shared key ID; incrementing, by the second controller, a value of the previously stored second shared key ID by the preset value to determine an updated second shared key ID; and storing, by the second controller, at least one of the incremented value of the previously stored second shared key ID or the updated second shared key ID.

The method may further comprise one or more steps and/or operations described herein.

### BRIEF DESCRIPTION OF THE DRAWINGS

The above and other objects, features and advantages of the present invention will become more apparent to those of ordinary skill in the art by describing exemplary examples thereof in detail with reference to the accompanying drawings, in which:

FIG. 1 shows an example diagram showing a vehicle according to an example.

FIG. 2 shows an example diagram showing a configuration of the vehicle according to an example.

FIG. 3 shows an example diagram to show a key pool of pre-shared keys according to an example.

FIG. 4A shows an example flowchart of an operation of a vehicle according to an example.

FIG. 4B shows an example flowchart of an operation of a vehicle according to an example.

FIG. 4C shows an example flowchart of an operation of a vehicle according to an example.

FIG. 5 shows an example flowchart to show a shared key validation operation according to an example.

FIG. 6 shows an example flowchart to show an authentication process according to an example.

FIG. 7 shows an example flowchart to show a protection mode entry operation according to an example.

FIG. 8 shows an example flowchart to show a protection mode release operation according to an example.

FIG. 9A shows an example flowchart to show an operation of a vehicle according to an example.

FIG. 9B shows an example flowchart to show an operation of a vehicle according to an example.

FIG. 9C shows an example flowchart to show an operation of a vehicle according to an example.

### DETAILED DESCRIPTION

Hereinafter, exemplary examples of the present invention will be described in detail with reference to the accompanying drawings.

However, the technical spirit of the present invention is not limited to some examples which will be described and may be implemented in a variety of different forms, and one or more components of the examples may be selectively combined, substituted, and used within the range of the technical spirit of the present invention.

In addition, unless clearly and specifically defined otherwise by the context, all terms (including technical and scientific terms) used herein can be interpreted as having meanings customarily understood by those skilled in the art, and the meanings of generally used terms, such as those defined in commonly used dictionaries, will be interpreted in consideration of contextual meanings of the related art.

In addition, the terms used in the examples of the present invention are considered in a descriptive sense only and not to limit the present invention.

In the present specification, unless specifically indicated otherwise by the context, singular forms include plural forms, and in a case in which “at least one (or one or more) among A, B, and C” is described, this may include at least one combination among all possible combinations of A, B, and C.

In addition, in descriptions of components of the present invention, terms such as “first,” “second,” “A,” “B,” “(a),” and “(b)” may be used.

The terms are only to distinguish one component from another component, and the essence, order, and the like of the components are not limited by the terms.

In addition, it should be understood that, when a first component is referred to as being “connected” or “coupled” to a second component, such a description may include both a case in which the first component is directly connected or coupled to the second component, and a case in which the first component is connected or coupled to the second component with a third component disposed therebetween.

In addition, when a first component is described as being formed or disposed “on” or “under” a second component, such a description includes both a case in which the two components are formed or disposed in direct contact with each other and a case in which one or more other components are interposed between the two components. In addition, when the first component is described as being formed “on or under” the second component, such a description may include a case in which the first component is formed at an upper side or a lower side with respect to the second component.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

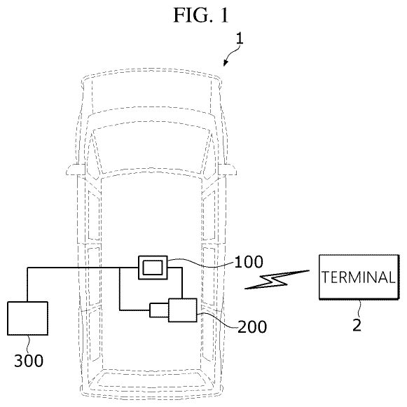

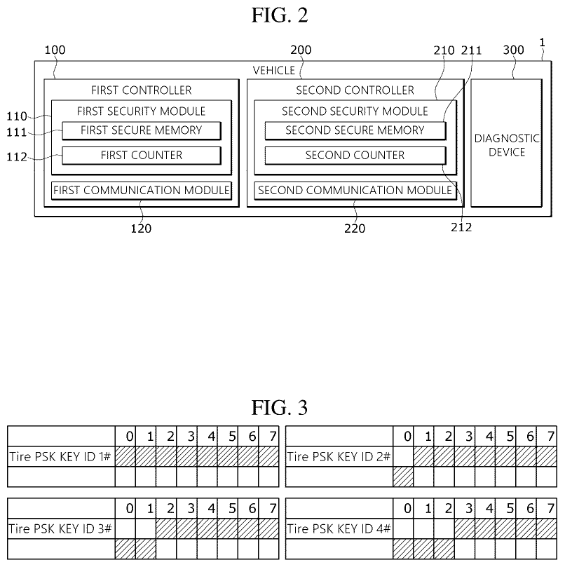

FIG. 1 shows an example diagram showing a vehicle 1 according to an example. FIG. 2 shows an example diagram showing a configuration of the vehicle according to the example. Referring to FIG. 1 and FIG. 2, the vehicle 1 according to the example may include a head unit 100 provided in a center fascia to control an audio device, an air conditioner, a Bluetooth device, and/or seat heating wires.

In the center fascia or the head unit 100, an input device for receiving user input may be disposed, and a display device for displaying operation information for at least one function performed within the vehicle 1 may be disposed.

The input device may include hardware devices such as various buttons, switches, pedals, keyboards, mice, track-balls, various levers, handles, sticks, etc.

Additionally or alternatively, the input device may include a graphical user interface (GUI) such as a touch pad, that is, a device that is software. The touch pad may be implemented as a touch screen panel (TSP) and may form a mutual layered structure with a display panel of a display unit.

An interior of a vehicle body may include a key groove into which a FOB (e.g., a key fob) type or card type remote controller may be inserted. For example, a key fob may comprise a small electronic device that may be used to access and/or control a vehicle without a physical key. The key groove may be provided (or located) in a dashboard or center fascia or provided in a location adjacent to a driver's seat.

The vehicle 1 may transmit and receive information to and from a remote controller or terminal if the remote controller is inserted into the key groove or if authentication with the remote controller or terminal is completed through a wireless communication network.

The interior of the vehicle body may include a start button that may receive a command to turn on/off the start of an engine. Accordingly, the vehicle may turn on the start of the engine if the start button is pushed by a user after completion of authentication with the remote controller or terminal.

The vehicle 1 may include a communication device for transmitting and receiving information to and from at least one of the electronic devices, the remote controller, and the terminal provided in the vehicle.

The communication device may include one or more components that may enable communication between components inside the vehicle, and may include, for example, at least one of a short-range communication module, a wired communication module, and a wireless communication module.

For example, the short-range communication module may include various short-range communication modules that transmit and receive signals using a wireless communication network at a short distance, such as a Bluetooth module, an infrared communication module, a radio frequency identification (RFID) communication module, a wireless local access network (WLAN) communication module, a near field communication (NFC) module, or a ZigBee communication module.

For example, the wired communication module may include not only various wired communication modules such as a controller area network (CAN) communication module, a local area network (LAN) module, a wide area network (WAN) module, or a value added network (VAN) module, but also various cable communication modules such as a Universal Serial Bus (USB), a High-Definition Multimedia Interface (HDMI), a Digital Visual Interface (DVI), Recommended Standard 232 (RS-232), power line communication, or a plain old telephone service (POTS).

For example, a controller area network (CAN) may comprise a communication protocol designed for real-time data exchange between microcontrollers and devices within vehicles and industrial systems. CAN may allow multiple electronic control units to communicate with each other without the need for a host computer, making it useful for applications where reliable, high-speed communication is critical.

For example, a value added network (VAN) may comprise a private network that may provide businesses with secure, reliable communication channels for exchanging data and documents. VANs may offer services (e.g., data encryption, format translation, message routing, or tracking, etc.) to ensure that business documents (e.g., invoices, purchase orders, or shipping notices, etc.) may be transmitted efficiently and/or securely between trading partners.

The wired communication module may include a local interconnect network (LIN). For example, a local interconnect network (LIN) may comprise a low-cost serial communication protocol that may be used in automotive systems to connect electronic components (e.g., sensors, actuators, or control units, etc.). For example, for simplicity and/or cost-efficiency, LIN may manage functions that do not require high-speed data transfer (e.g., window controls, seat adjustments, lighting, or climate control, etc.). LIN may function on a single-master, multiple-slave architecture, where one master node may coordinate communication with multiple slave nodes.

Additionally or alternatively, the wireless communication module may include, in addition to a Wi-Fi module and a wireless broadband module, wireless communication modules that support various wireless communication methods, such as Global System for Mobile Communications (GSM), Code Division Multiple Access (CDMA), Wideband Code Division Multiple Access (W-CDMA), Universal Mobile Telecommunications System (UMTS), Time Division Multiple Access (TDMA), Long Term Evolution (LTE), etc.

A terminal 2 may communicate with the vehicle 1. A terminal 2 may receive at least one of locking and unlocking commands for vehicle doors, locking and unlocking commands for a tailgate, an engine start command. A terminal 2 may command to turn lamps on and off. A terminal 2 may transmit information corresponding to the received command to the vehicle 1. The terminal may transmit the information corresponding to the received command to the vehicle 1 as a communication signal.

The terminal 2 may be implemented as a computer or portable terminal that may be communicatively connected to the vehicle through a network.

The computer may include, for example, a notebook computer, a desktop, a laptop, a tablet PC, a slate PC equipped with a web browser, etc. The portable terminal is, for example, a wireless communication device that ensures portability and mobility, and may include any type of handheld-based wireless communication devices such as a Personal Communication System (PCS) terminal, a GSM terminal, a Personal Digital Cellular (PDC) terminal, a Personal Handyphone System (PHS) terminal, a Personal Digital Assistant (PDA) terminal, an International Mobile Telecommunication (IMT)-2000 terminal, a CDMA-2000 terminal, a W-CDMA terminal, a Wireless Broadband Internet (WiBro) terminal, a smartphone, etc. and a wearable device such as a watch, a ring, a bracelet, an anklet, a necklace, glasses, contact lenses, a head-mounted-device (HMD), etc.

For example, the terminal 2 may communicate with the vehicle 1 through a Bluetooth Low Energy (BLE) communication method. Such a terminal may communicate using the Bluetooth beacon standard (iBeacon).

A first controller 100 may be a component in the vehicle 1 that may provide a hardware interface integrated into a vehicle system. For example, the first controller 100 may be a head unit or an infotainment system. The first controller 100 may perform system control targeted for screens, buttons, and various integrated information and entertainment functions. In the following examples, the first controller 100 may be described as a head unit. One or more controllers described herein may include one or more processors, one or more memory and/or one or more storage devices. One or more controllers the vehicle may disable operation control of one or more components of the vehicle, based on a result of one or more authentication processes and/or verification processes described herein. The vehicle components may include one or more sensors (e.g., camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, etc.), for example, for autonomous driving control. The vehicle components may also include an auxiliary braking system (e.g., hydraulic retarder, electric retarder), an auxiliary device (e.g., engine brake, exhaust brake, hydraulic retarder, electric retarder, regenerative brake, etc.), a motor, a battery management system, a battery, a communication interface, a controller, a user interface, a key fob, a steering wheel, etc.

The first controller 100 may be installed in the console or the center of the dashboard of the vehicle and provide a vehicle information and entertainment interface. Information and entertainment systems may include AM/FM radio, satellite radio, digital versatile discs (DVDs)/compact discs (CDs), cassette tapes, USB MP3, dashcams, GPS navigation, Bluetooth, Wi-Fi, etc. Information and entertainment systems may provide state information of the vehicle system. Additionally or alternatively, the first controller 100 may perform functions such as voice control and motion recognition.

The first controller 100 may include a first security module 110 and a first communication module 120.

The first security module (e.g., hardware security module (HSM)) 110 may perform a device authentication operation. The first security module 110 may be implemented in software, hardware, or firmware.

The first security module 110 may be an encryption processor designed to protect a life cycle of an encryption key. The first security module 110 may perform encryption processing, key protection, and key management within an enhanced anti-counterfeiting device. The first security module 110 may be used in a vehicle controller domain, and may be provided with a secure memory 111 that may safely store keys. For example, the secure memory 111 may include an HSM dedicated random access memory (RAM) or read only memory (ROM) having high security, separately from a host system. The first security module 110 may perform a security function against attacks by potential attackers by performing a series of operations through a dedicated central processing unit (CPU). In the secure memory 111, a key pool from which a plurality of pre-shared keys (PSKs) may be extracted and a shared key ID may be stored. The first security module 110 may access a key pool of PSKs using the shared key ID and extract the PSK corresponding to the shared key ID.

The first security module 110 may include a counter 112 that generates counter information. Here, the counter 112 may be defined as a register or memory device used to indicate the number of occurrences of a specific event. If a next input signal or an input pulse is received in an existing state, the counter 112 may increment an existing value by one and store the existing value as a new value. For example, the first security module 110 may increment a value of a first shared key ID by one each time an authentication process succeeds and store the value in the secure memory 111.

The first communication module 120 may perform data communication with a second controller 200 using at least one communication method among a CAN protocol, an Ethernet protocol, and a LIN protocol.

A second controller 200 may control a vehicle body such as a vehicle, a door, a window, a key (a digital key, a smartphone key, and an FOB), etc. The second controller 200 may perform a body control function (e.g., a body control module (BCM)), a smart key (SMK) entry/start function, a tire pressure monitoring function (e.g., a tire pressure monitoring system (TPMS)), an immobilizer (IMMO) function, a digital key authentication (e.g., an identity authentication unit (IAU)), an autonomous parking related control function (e.g., parking distance warning (PDW)), etc. For example, the second controller 200 may be a body domain controller (BDC), but is not limited thereto, and may be used as a controller encompassing a platform controller that provides electronic convenience functions to a body domain area.

The second controller 200 may include a second security module 210 and a second communication module 220.

The second security module (e.g., hardware security module (HSM)) 210 may perform the device authentication operation. The second security module 210 may be implemented in software, hardware, or firmware.

The second security module 210 may be an encryption processor designed to protect a life cycle of an encryption key. The second security module 210 may perform encryption processing, key protection, and key management within an enhanced anti-counterfeiting device. The second security module 210 may be used in a vehicle controller domain, and may be provided with a secure memory 211 that may safely store keys. For example, the secure memory 211 may include the HSM-dedicated RAM or ROM having high security, separately from the host system. The second security module 210 may perform a security function against attacks by potential attackers by performing a series of operations through a dedicated CPU. In the secure memory 211, a key pool from which a plurality of PSKs may be extracted and a shared key ID may be stored. The second security module 210 may access a key pool of PSKs using the shared key ID and extract the PSK corresponding to the shared key ID.

The second security module 210 may include a counter 212 that generates counter information. For example, the counter 212 may be defined as a register or memory device used to indicate the number of occurrences of a specific event. If a next input signal or an input pulse is received in an existing state, the counter 212 may increment an existing value by one and store the existing value as a new value. For example, the second security module 210 may increment a value of a second shared key ID by one each time an authentication process succeeds and store the value in the secure memory 211.

The second communication module 220 may perform data communication with the first controller 100 using at least one communication method among the CAN protocol, the Ethernet protocol, and the LIN protocol.

A diagnostic device 300 may be a device that is externally connected to the vehicle 1 and executes a program that may ascertain a state of the vehicle and diagnose the state. The diagnostic device 300 may include, for example, a notebook computer, a desktop, a laptop, a tablet PC, a slate PC equipped with a web browser, etc. The portable terminal may be, for example, a wireless communication device that ensure portability and mobility, and may include any type of handheld-based wireless communication devices such as a PCS terminal, a GSM terminal, a PDC terminal, a PHS terminal, a PDA terminal, an IMT-2000 terminal, a CDMA-2000 terminal, a W-CDMA terminal, a WiBro terminal, a smartphone, etc. For example, the diagnostic device 300 may be, but is not limited to, a global diagnostic system (GDS), and may be any electronic device that may be connected to the vehicle 1 to ascertain a state of the vehicle 1 and diagnose the state.

The diagnostic device 300 may be connected to the first controller 100 and the second controller 200 through a wired or wireless communication method, and may extract information from the first controller 100 and the second controller 200 and determine the current state thereof.

Additionally or alternatively, the diagnostic device 300 may generate a shared key ID for an authentication process of the first controller 100 and the second controller 200 and transmit the shared key ID to the first controller 100 and the second controller 200, and may provide vehicle information such as a personal identification number (PIN) and a vehicle identification number (VIN) required for the authentication process.

For example, the first controller 100 and the second controller 200 store the same key pool from which a plurality of PSKs may be extracted in the secure memory in advance. For example, a capacity of the key pool may be set to be larger than a capacity of the PSK. For example, extraction of the PSK may mean a process of selecting a specific PSK among a plurality of PSKs constituting the key pool in a predetermined manner using the shared key ID. The key pool may be injected into each controller with positions of a plurality of bytes constituting the key pool fixed, or may be used by confirming the positions of the plurality of bytes by changing the arrangement order in units of predetermined bytes through an obfuscated function after injecting the positions of the plurality of bytes constituting the key pool into the controller in a random arrangement order.

For example, the PSK and the shared key may be used with the same meaning. Additionally or alternatively, the shared key ID, the PSK ID, and a key ID may be used with the same meaning.

The first controller 100 and the second controller 200 may perform identity authentication to ensure data security if exchanging data. The first controller 100 and the second controller 200 may verify each other's identities through a process of exchanging an encrypted message with each other and verifying the encrypted message. For example, in order to ensure transmission security of an encrypted message, important information in the encrypted message may be encrypted using an encryption key, and integrity verification information in the encrypted message may be computed using an integrity verification key. The encryption key and the integrity verification key may be obtained based on the PSK. Each of the first controller 100 and the second controller 200 may store the PSK in advance, and the PSK stored in the first controller 100 in advance may be the same as the PSK stored in the second controller 200 in advance. In the identity authentication process, the first controller 100 and the second controller 200 may separately derive the encryption key and the integrity verification key based on the PSK stored in advance.

For example, the PSK stored in the first controller 100 and the second controller 200 in advance may be maintained without any change. For example, the PSK may be maintained without any change from the time of delivery of a vehicle to the time of disposal of the vehicle, but is not limited thereto.

FIG. 3 shows an example flowchart to show a frame in which an ID of a PSK is constituted according to an example. For example, an existing PSK ID was utilized by directly storing a bit signal corresponding to information of an associated shared key in a secure memory. Referring to FIG. 3, the PSK according to the example may be used by distinguishing a PSK ID with a bit signal, so that the number of PSKs that may be managed in the same memory area may be increased.

For example, conventionally, each PSK ID was previously stored as 8-bit signal information, but in the example, a frame composed of 2 bytes was used to configure the PSK ID to correspond to a sequentially incremented bit signal.

If configuring the frame of a PSK ID as in the example, there may be a technical effect of being able to utilize a shared key ID whose number is increased by a factor of N (e.g., N is the length of the shared key ID) compared to the existing number of shared key IDs in the same memory area.

For convenience, one or more figures are described by way of an example in which the steps are performed by a processor circuit. One, some, or all steps of the example method of a figure, or portions thereof, may be performed by one or more other circuits. One or some, steps of the example method of a figure may be omitted, performed in other orders, and/or otherwise modified, and/or one or more additional steps may be added.

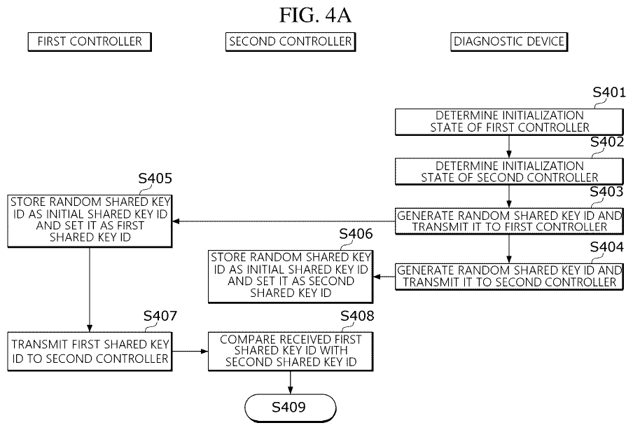

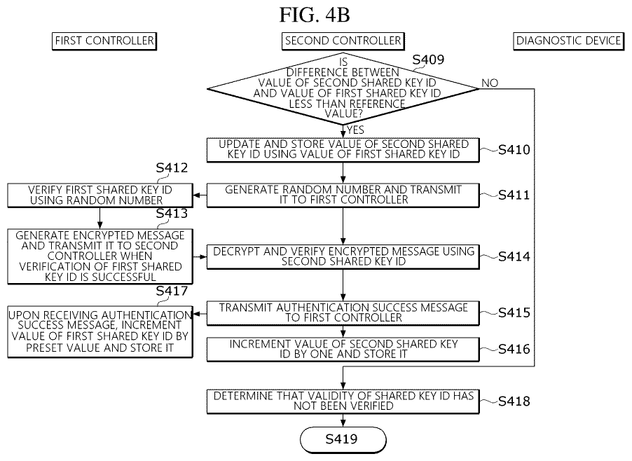

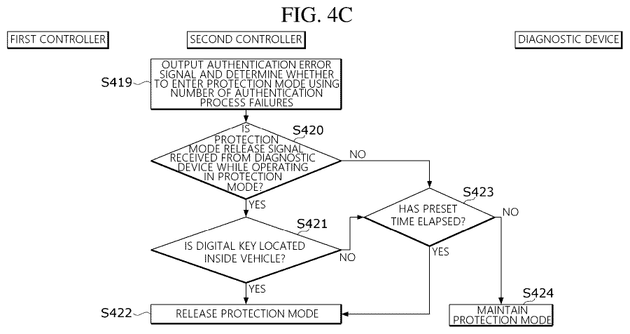

FIGS. 4A to 4C show example flowcharts of operations of a vehicle according to an example.

Referring to FIGS. 4A to 4C, a diagnostic device may determine a state of a first controller and a second controller. The diagnostic device may determine a state of the first controller and the second controller using a shared key ID stored in the first controller and the second controller. For example, the diagnostic device may determine that the first controller and the second controller may be in an uninitialized state if an initial shared key ID is stored in the first controller and the second controller or if a value of the shared key ID is incremented. If the initial shared key ID is not stored in the first controller and the second controller, the diagnostic device may determine that the first controller and the second controller may be in an initialized state (S401 and S402).

Additionally or alternatively, if the states of the first controller and the second controller are different from each other, that is, if one controller is in an initialized state and the other controller is in an uninitialized state, the diagnostic device may determine that the first controller and the second controller are in the initialized state.

If the first controller and second controller are in the initialized state, the diagnostic device may generate a random shared key ID and transmit the random shared key ID to the first controller and the second controller. The random shared key ID may be generated using a random number function (S403 and S404).

The first controller in the initialization state may store the random shared key ID received from the diagnostic device as an initial shared key ID and set the random shared key ID as a first shared key ID (S405).

The second controller in the initialization state may store the received random shared key ID as an initial shared key ID and set the received random shared key ID as a second shared key ID (S406).

An authentication process may be initiated according to an authentication request from the first controller.

The first controller may transmit the first shared key ID to the second controller (S407).

The second controller may compare the received first shared key ID with the second shared key ID (S408).

If a difference between a value of the second shared key ID and a value of the first shared key ID is less than a reference value, the second controller may determine that validity of the shared key ID has been verified. If the shared key ID is valid, the second controller may update and store the value of the second shared key ID using the value of the first shared key ID (S409 and S410).

If the validity of the shared key ID has been verified, the second controller may generate a random number and transmit the random number to the first controller (S411).

The first controller may verify the first shared key ID using the random number received from the second controller, and generate an encrypted message and transmit the encrypted message to the second controller if the verification of the first shared key ID is successful (S412 and S413).

The second controller may decrypt and verify the encrypted message using the second shared key ID (S414).

If the decryption and verification of the encryption message are successfully completed, the second controller may transmit an authentication success message indicating that the authentication process is successful to the first controller (S415).

If the authentication process is successful, the second controller may increment a value of the second shared key ID by a preset value and store the value. For example, the second controller may increment the value of the second shared key ID by one and store the value in the secure memory. If the value of the second shared key ID is the maximum, the second controller may store a value of the initial shared key ID as the value of the second shared key ID (S416).

Upon receiving the authentication success message, the first controller may increment a value of the first shared key ID by the preset value and store the value. For example, the first controller may increment the value of the first shared key ID by one and store the value in the secure memory. If the value of the first shared key ID is the maximum, the first controller may store a value of the initial shared key ID as the value of the first shared key ID (S417).

For example, if a difference between the value of the second shared key ID and the value of the first shared key ID is a reference value or more, the second controller may determine that the validity of the shared key ID has not been verified (S418).

If the validity of the shared key ID has not been verified, the second controller may output an authentication error signal and determine whether to enter a protection mode using the number of authentication process failures (S419).

For example, if the validity of the shared key ID has not been verified consecutively a preset number of times or more during a preset time, the second controller may enter the protection mode and stop the authentication process.

The protection mode may be a mode that operates to prevent the authentication process from being performed for a predetermined time. While operating in the protection mode, the second controller may not perform verification of the validity of the shared key ID and the authentication process even upon receiving an authentication request. Through the protection mode, the second controller may prevent attacks through repeated hacking attempts for a short time.

The second controller may receive a protection mode release signal from the diagnostic device while operating in the protection mode (S420).

Upon receiving the protection mode release signal, the second controller may determine whether a digital key is located inside the vehicle (S421).

The second controller may release the protection mode if it is determined that the digital key is located inside the vehicle (S422).

Additionally or alternatively, the second controller may release the protection mode after a predetermined time elapses. For example, the second controller may release the protection mode one hour after entering the protection mode, and the predetermined time may be set differently depending on an operating environment and security environment of the vehicle (S423).

If the release conditions described above are not met, the second controller may maintain the protection mode (S424).

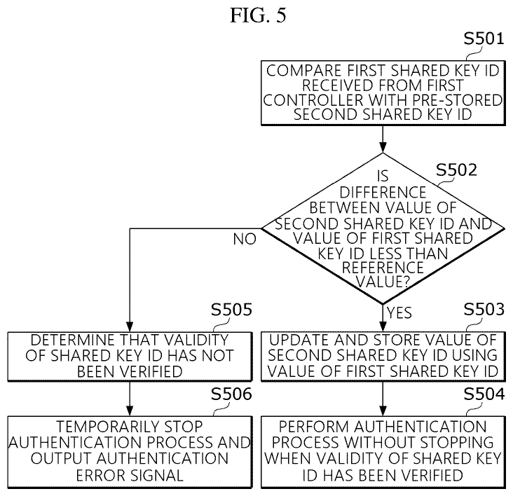

FIG. 5 shows an example flowchart to show a shared key validation operation according to an example.

Referring to FIG. 5, the second controller may compare the first shared key ID received from the first controller with a previously stored second shared key ID (S501).

If the difference between the value of the second shared key ID and the value of the first shared key ID is less than the reference value, the second controller may determine that the validity of the shared key ID has been verified. If the shared key ID is valid, the second controller may update and store the value of the second shared key ID using the value of the first shared key ID. For example, if the difference value between the value of the second shared key ID and the value of the first shared key ID is less than two, the second controller may determine that the validity of the shared key ID has been verified (S502 and S503).

If the validity of the shared key ID has been verified, the second controller may perform the authentication process without stopping (S504).

For example, if a difference between the value of the second shared key ID and the value of the first shared key ID is a reference value or more, the second controller may determine that the validity of the shared key ID has not been verified. For example, if the difference value between the value of the second shared key ID and the value of the first shared key ID is two or more, the second controller may determine that the validity of the shared key ID has not been verified (S505).

If the validity of the shared key ID has not been verified, the second controller may temporarily stop the authentication process and output an authentication error signal (S506).

Through this configuration, the vehicle according to the example may prevent leakage and attack of the shared key depending on the number of manipulations of the shared key ID and authentication process.

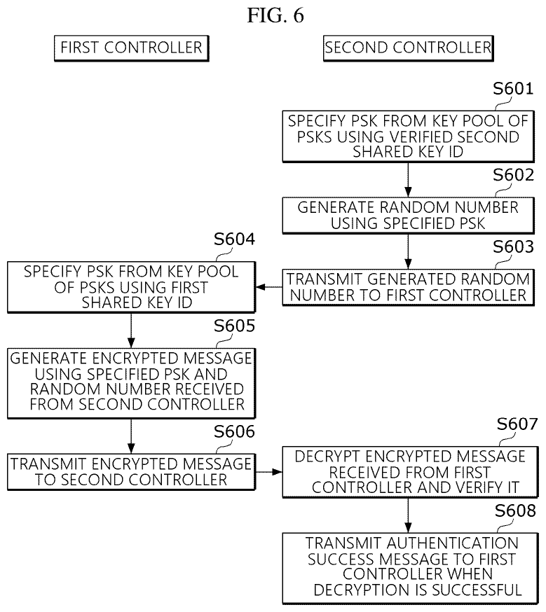

FIG. 6 shows an example flowchart to show an authentication process according to an example.

Referring to FIG. 6, the second controller may specify a PSK from a key pool of PSKs using a verified second shared key ID. The second controller may generate a random number using the specified PSK. The second controller may transmit the generated random number to the first controller (S601 to S603).

The first controller may specify the PSK from the key pool of PSKs using the first shared key ID. The first controller may generate an encrypted message using the specified PSK and the random number received from the second controller (S604 and S605).

The first controller may transmit the encrypted message to the second controller (S606).

The second controller may decrypt the encrypted message received from the first controller and verify the encrypted message. The second controller may decrypt the encrypted message received from the first controller using the random number generated in the previous process and the specified PSK. If decryption is successful, the second controller may transmit an authentication success message to the first controller (S607 and S608).

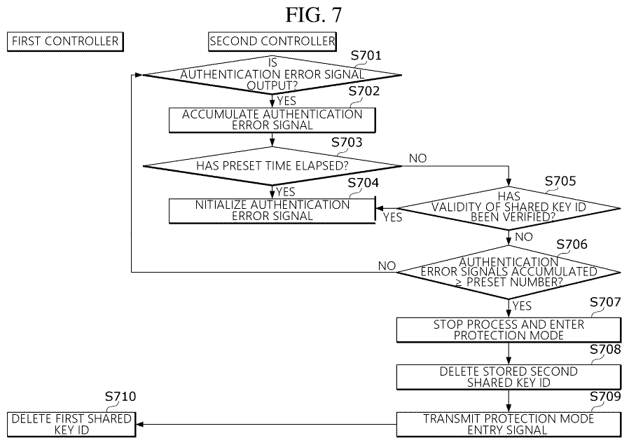

FIG. 7 shows an example flowchart to show a protection mode entry operation according to an example.

Referring to FIG. 7, if outputting an authentication error signal, the second controller may use a counter to accumulate and calculate the number of outputs of the authentication error signal (S701 and S702).

The second controller may initialize the number of outputs of the authentication error signal at each preset time. Additionally or alternatively, the second controller may initialize the number of outputs of the authentication error signal if the validity of the shared key ID has been verified. For example, the preset time may be set to ten minutes or set differently depending on the operating environment and security environment of the vehicle (S703 to S705).

The second controller may start a timer according to the preset time if the number of occurrences of the authentication error signal is one.

The second controller may stop the authentication process and enter the protection mode if the number of outputs of the authentication error signal is accumulated to a preset number or more. For example, the preset number may be set to three, or the preset number may be set differently depending on the operating environment and security environment of the vehicle (S706 and S707).

The protection mode may be a mode that operates to prevent the authentication process from being performed for a predetermined time. While operating in the protection mode, the second controller may not perform verification of the validity of the shared key ID and/or the authentication process, for example, even upon receiving the authentication request. Through the protection mode, the second controller may prevent attacks through repeated hacking attempts for a short time in advance.

Upon entering the protection mode, the second controller may delete a stored second shared key ID (S708).

The second controller may transmit a protection mode entry signal to the first controller (S709).

Upon receiving the protection mode entry signal, the first controller may delete the first shared key ID (S710).

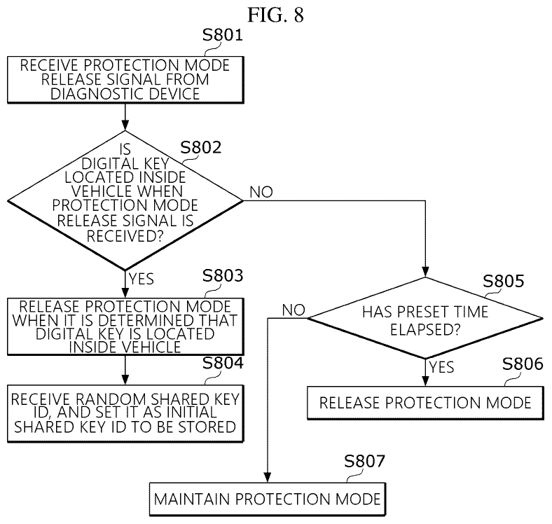

FIG. 8 shows an example flowchart to show a protection mode release operation according to an example.

The second controller may receive a protection mode release signal from the diagnostic device while operating in the protection mode (S801).

Upon receiving the protection mode release signal, the second controller may determine whether a digital key is located inside the vehicle. The second controller may measure a location of the digital key using intensity values of a plurality of signals received from the digital key (S802).

If it is determined that the digital key is located inside the vehicle, the second controller may release the protection mode. If the protection mode is released, each of the first controller and the second controller may receive a random shared key ID from the diagnostic device, set the random shared key ID as an initial shared key ID thereof, and store the initial shared key ID. The release of the protection mode through the diagnostic device may be performed under the condition that the digital key is located inside the vehicle if there is an urgent need to use the authentication process (S803 and S804).

Additionally or alternatively, the second controller may release the protection mode after a predetermined time elapses. For example, the second controller may release the protection mode, for example, one hour after entering the protection mode, and the predetermined time may be set differently depending on the operating environment and/or the security environment of the vehicle (S805 and S806).

If the protection mode release conditions are not met, the second controller may maintain the protection mode for a predetermined time (S807).

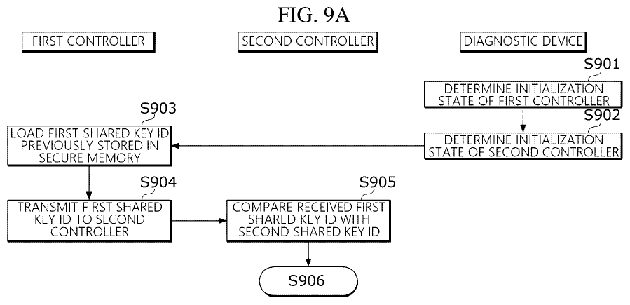

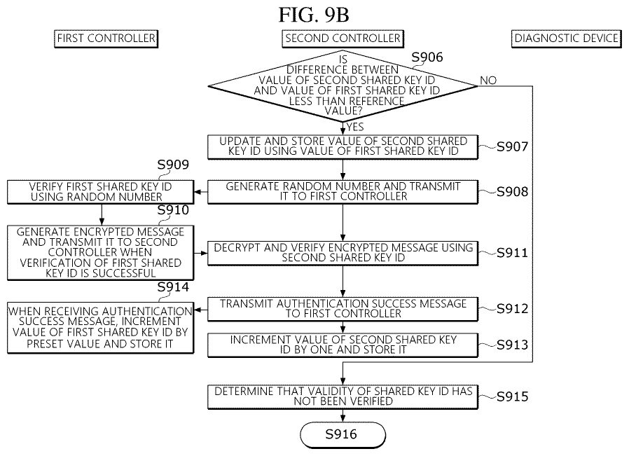

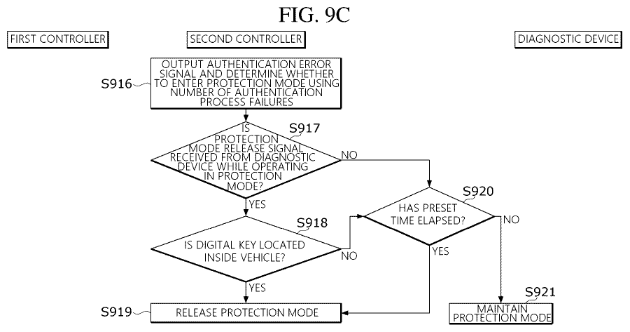

FIGS. 9A to 9C show examples of flowcharts to show operations of a vehicle according to another example.

Referring to FIGS. 9A to 9C, a diagnostic device may determine a state of a first controller and a second controller. The diagnostic device may determine a state of the first controller and the second controller using the shared key ID stored in the first controller and the second controller. For example, the diagnostic device may determine that the first controller and the second controller may be in an uninitialized state if an initial shared key ID is stored in the first controller and the second controller or if a value of a shared key ID is incremented. If the initial shared key ID is not stored in the first controller and the second controller, the diagnostic device may determine that the first controller and the second controller may be in an initialized state (S901 and S902).

Additionally or alternatively, if the states of the first controller and the second controller are different from each other (e.g., if one controller is in an initialized state and the other controller is in an uninitialized state), the diagnostic device may determine that the first controller and the second controller may be in the initialized state.

If the first controller and second controller are in the uninitialized state, the diagnostic device may not separately perform a process of generating a random shared key ID, and the first controller and the second controller may initiate an authentication process without storing the initial shared key ID.

The first controller in the uninitialized state may read a first shared key ID previously stored in the secure memory. For example, the first shared key ID may be an initial shared key ID whose value has been incremented by the number of times the authentication process was successful through a previous authentication process (S903).

The first controller may transmit a first shared key ID to the second controller (S904).

The second controller may compare the received first shared key ID with a second shared key ID. The second shared key ID may be an initial shared key ID whose value has been incremented by the number of times the authentication process was successful through the previous authentication process (S905).

If a difference between a value of the second shared key ID and a value of the first shared key ID is less than a reference value, the second controller may determine that validity of the shared key ID has been verified. If the shared key ID is valid, the second controller may update and store the value of the second shared key ID using the value of the first shared key ID (S906 and S907).

If the validity of the shared key ID has been verified, the second controller may generate a random number and transmit the random number to the first controller (S908).

The first controller may verify the first shared key ID using the random number received from the second controller, and generate an encrypted message and transmit the encrypted message to the second controller if the verification of the first shared key ID is successful (S909 and S910).

The second controller may decrypt and verify the encrypted message using the second shared key ID (S911).

If the decryption and verification of the encryption message are successfully completed, the second controller may transmit an authentication success message indicating that the authentication process is successful to the first controller (S912).

If the authentication process is successful, the second controller may increment the value of the second shared key ID by a preset value and store the value. For example, the second controller may increment the value of the second shared key ID by one and store the value in a secure memory. If the value of the second shared key ID is the maximum, the second controller may store the value of the initial shared key ID as the value of the second shared key ID (S913).

Upon receiving the authentication success message, the first controller may increment the value of the first shared key ID by a preset value and store the value. For example, the first controller may increment the value of the first shared key ID by one and store the value in the secure memory. If the value of the first shared key ID is the maximum, the first controller may store the value of the initial shared key ID as the value of the first shared key ID (S914).

For example, if a difference between the value of the second shared key ID and the value of the first shared key ID is a reference value or more, the second controller may determine that the validity of the shared key ID has not been verified (S915).

If the validity of the shared key ID has not been verified, the second controller may output an authentication error signal and determine whether to enter a protection mode using the number of authentication process failures (S916).

For example, if the validity of the shared key ID has not been verified consecutively a preset number of times or more during a preset time, the second controller may enter the protection mode and stop the authentication process.

The protection mode may be a mode that operates to prevent the authentication process from being performed for a predetermined time. While operating in the protection mode, the second controller may not perform verification of the validity of the shared key ID and the authentication process even upon receiving an authentication request. Through the protection mode, the second controller may prevent attacks through repeated hacking attempts for a short time.

The second controller may receive a protection mode release signal from the diagnostic device while operating in the protection mode (S917).

Upon receiving the protection mode release signal, the second controller may determine whether a digital key is located inside the vehicle (S918).

If it is determined that the digital key is located inside the vehicle, the second controller may release the protection mode (S919).

Additionally or alternatively, the second controller may release the protection mode after a predetermined time elapses. For example, the second controller may release the protection mode, for example, one hour after entering the protection mode, and the predetermined time may be set differently depending on the operating environment and security environment of the vehicle (S920).

If the release conditions described above are not met, the second controller may maintain the protection mode (S921).

According to an aspect of the present invention, there is provided a vehicle including a first controller that requests a first authentication process by transmitting a previously stored first shared key ID, and a second controller that verifies validity of a shared key ID by comparing a previously stored second shared key ID with the first shared key ID according to the request for the first authentication process, and performs the first authentication process using the shared key ID of which validity has been verified, in which, when an identity is authenticated through the first authentication process, the first controller increments a value of the first shared key ID by a preset value and stores the value of the first shared key ID and the second controller increments a value of the second shared key ID by the preset value and stores the value of the second shared key ID.

When a second authentication process is performed, the first controller and the second controller may perform the second authentication process using an incremented shared key ID.

The first controller may request the second authentication process by transmitting an incremented first shared key ID to the second controller, and the second controller may verify the validity of the shared key ID by comparing an incremented second shared key ID with the incremented first shared key ID according to the request for the second authentication process.

Each of the first controller and the second controller may receive a random shared key ID generated from a diagnostic device and store the random shared key ID as an initial shared key ID thereof.

When the identity is authenticated, each of the first controller and the second controller may increment a value of the shared key ID thereof by one according to the preset value and store the value.

When the validity of the shared key ID has been verified, the second controller may generate a random number and transmit the random number to the first controller.

The first controller may verify the first shared key ID using the random number received from the second controller, and generate an encrypted message and transmit the encrypted message to the second controller when the verification of the first shared key ID is successful.

When a difference between the value of the second shared key ID and the value of the first shared key ID is less than a reference value, the second controller may determine that the validity of the shared key ID has been verified, and update and store the value of the second shared key ID using the value of the first shared key ID.

When a difference between the value of the second shared key ID and the value of the first shared key ID is a reference value or more, the second controller may determine that the validity of the shared key ID has not been verified and output a verification error signal.

When authentication of the identity consecutively fails for a preset number of times or more during a preset time, the second controller may enter a protection mode and stop an authentication process.

Upon receiving a protection mode release signal from the diagnostic device, the second controller may determine whether a digital key is located inside a vehicle and release the protection mode.

According to another aspect of the present invention, there is provided a vehicle network security method including requesting, by a first controller, a first authentication process by transmitting a previously stored first shared key ID, verifying, by a second controller, validity of a shared key ID by comparing a previously stored second shared key ID with the first shared key ID according to the request for the first authentication process, performing, by the first controller and the second controller, the first authentication process using the shared key ID of which validity has been verified, and when an identity is authenticated through the first authentication process, incrementing, by the first controller and the second controller, a value of the shared key ID of each of the first controller and the second controller by a preset value and storing the value.

The vehicle network security method may further include requesting, by the first controller, a second authentication process by transmitting an incremented first shared key ID, verifying, by the second controller, the validity of the shared key ID by comparing an incremented second shared key ID with the incremented first shared key ID according to the request for the second authentication process, and performing, by the first controller and the second controller, a second authentication process using the shared key ID of which validity has been verified.

The vehicle network security method may further include, before the requesting of the first authentication process, receiving, by the first controller and the second controller, a random shared key ID generated from a diagnostic device and storing the random shared key ID as an initial shared key ID of each of the first controller and the second controller.

When the identity is authenticated, each of the first controller and the second controller may increment a value of the shared key ID thereof by one according to the preset value and store the value.

The performing of the first authentication process may include, when the validity of the shared key ID has been verified, generating, by the second controller, a random number and transmitting the random number to the first controller, verifying, by the first controller, the first shared key ID using the random number received from the second controller, when the verification of the first shared key ID is successful, generating, by the first controller, an encrypted message and transmitting the encrypted message to the second controller, and decrypting and verifying, by the second controller, the encrypted message using the second shared key ID.

The verifying of the validity of the shared key ID may include, when a difference between a value of the second shared key ID and a value of the first shared key ID is less than a reference value, determining, by the second controller, that the validity of the shared key ID has been verified, and updating and storing the value of the second shared key ID using the value of the first shared key ID.

The verifying of the validity of the shared key ID may include, when a difference between a value of the second shared key ID and a value of the first shared key ID is a reference value or more, determining, by the second controller, that the validity of the shared key ID has not been verified and outputting a verification error signal.

The vehicle network security method may further include, when authentication of the identity consecutively fails for a preset number of times or more during a preset time when the shared key ID is determined to be invalid, causing the second controller to enter a protection mode and stop the authentication process.

The vehicle network security method may further include, upon receiving a protection mode release signal from a diagnostic device, determining, by the second controller, whether a digital key is located inside the vehicle and releasing the protection mode.

A vehicle and vehicle network security method according to an example may prevent a hacker's attack in a situation where a PSK is leaked.

Additionally or alternatively, a PSK ID may be expanded.

Additionally or alternatively, it is possible to prevent a hacker from reversely estimating a shared key ID, for example, based on the number of authentication successes according to information such as usage time and frequency of use.

Additionally or alternatively, it is possible to solve the problem of collapse of a security system due to a hacker's attack through repeated authentication.

While the present invention has been mainly described above with reference to examples, it will be understood by those skilled in the art that the present invention is not limited to the examples, the examples are only exemplary, and various modifications and applications, which are not exemplified above, may be made within the range of the present invention without departing from the essential features of the present examples. For example, components specifically described in the examples may be implemented with modifications. In addition, it should be interpreted that differences related to such modifications and applications fall within the scope of the present invention defined by the appended claims.

What is claimed is:

1. A vehicle comprising:
a first controller configured to initiate a first authentication process by transmitting a previously stored first shared key identity (ID); and
a second controller configured to:
receive, from the first controller, a request for performing the first authentication process and the previously stored first shared key ID;
verify, based on the request, validity of the previously stored first shared key ID by comparing a previously stored second shared key ID with the previously stored first shared key ID, and
perform, using the previously stored first shared key ID of which validity has been verified, the first authentication process,
wherein, based on an identity associated with the first authentication process being authenticated via the first authentication process;
the first controller is configured to:
increment a value of the previously stored first shared key ID by a preset value to determine an updated first shared key ID; and
store at least one of the incremented value of the previously stored first shared key ID or the updated first shared key ID, and
the second controller is configured to:
increment a value of the previously stored second shared key ID by the preset value to determine an updated second shared key ID; and
store at least one of the incremented value of the previously stored second shared key ID or the updated second shared key ID.

2. The vehicle of claim 1, wherein, based on a second authentication process being initiated, the second controller is configured to perform the second authentication process using the updated first shared key ID and the updated second shared key ID.

3. The vehicle of claim 2, wherein:
the first controller is configured to initiate the second authentication process by transmitting the updated first shared key ID to the second controller; and
the second controller is configured to:
receive, from the first controller, a second request for performing the second authentication process and the updated first shared key ID; and
verify, based on the second request, validity of the updated first shared key ID by comparing the updated second shared key ID with the updated first shared key ID.

4. The vehicle of claim 1, wherein each of the first controller and the second controller is configured to receive, from a diagnostic device, a random shared key ID generated and store the random shared key ID as an initial shared key ID for the first controller and the second controller, respectively.

5. The vehicle of claim 1, wherein the preset value corresponds to one.

6. The vehicle of claim 1, wherein, based on the validity of the previously stored first shared key ID has been verified, the second controller is configured to generate a random number and transmit the random number to the first controller.

7. The vehicle of claim 6, wherein the first controller is configured to:
verify, using the random number received from the second controller, the previously stored first shared key ID; and
based on the verification of the previously stored first shared key ID being successful, generate an encrypted message and transmit the encrypted message to the second controller.

8. The vehicle of claim 1, wherein, based on a difference between the value of the previously stored second shared key ID and the value of the previously stored first shared key ID being less than a reference value, the second controller is configured to:
determine that the validity of the previously stored first shared key ID has been verified, and
update and store the value of the previously stored second shared key ID using the value of the previously stored first shared key ID.

9. The vehicle of claim 1, wherein, based on a difference between the value of the previously stored second shared key ID and the value of the previously stored first shared key ID being greater than or equal to a reference value, the second controller is configured to determine that the validity of the previously stored first shared key ID has not been verified and output a verification error signal.

10. The vehicle of claim 9, wherein, based on a determination that authentication of the identity consecutively fails for a preset number of times or more during a preset time period, the second controller is configured to activate a protection mode and stop a key authentication process.

11. The vehicle of claim 10, wherein, based on receiving a protection mode release signal from a diagnostic device, the second controller is configured to determine whether a digital key is located inside the vehicle and release the protection mode.

12. A method performed by a vehicle, the method comprising:
initiating, by a first controller of the vehicle, a first authentication process by transmitting a previously stored first shared key identity (ID);
receiving, by a second controller of the vehicle from the first controller, a request for performing the first authentication process and the previously stored first shared key ID;
based on the request, verifying, by the second controller, validity of the previously stored first shared key ID by comparing a previously stored second shared key ID with the previously stored first shared key ID;
using the previously stored first shared key ID of which validity has been verified, performing, by the first controller and the second controller, the first authentication process; and
based on an identity associated with the first authentication process being authenticated via the first authentication process:
incrementing, by the first controller, a value of the previously stored first shared key ID by a preset value to determine an updated first shared key ID;
storing, by the first controller, at least one of the incremented value of the previously stored first shared key ID or the updated first shared key ID;
incrementing, by the second controller, a value of the previously stored second shared key ID by the preset value to determine an updated second shared key ID; and
storing, by the second controller, at least one of the incremented value of the previously stored second shared key ID or the updated second shared key ID.

13. The method of claim 12, further comprising:
initiating, by the first controller, a second authentication process by transmitting the updated first shared key ID to the second controller;
receiving, by the second controller from the first controller, a second request for performing the second authentication process and the updated first shared key ID;
based on the second request, verifying, by the second controller, validity of the updated first shared key ID by comparing the updated second shared key ID with the updated first shared key ID; and
performing, by the first controller and the second controller, the second authentication process using the updated first shared key ID of which validity has been verified.

14. The method of claim 12, further comprising, before the initiating of the first authentication process, receiving, by the first controller and the second controller, a random shared key ID generated from a diagnostic device and storing, by the first controller and the second controller, the random shared key ID as an initial shared key ID for each of the first controller and the second controller.

15. The method of claim 12, wherein the preset value corresponds to one.

16. The method of claim 12, wherein the performing of the first authentication process comprises:
based on the validity of the previously stored first shared key ID has been verified, generating, by the second controller, a random number and transmitting the random number to the first controller;
verifying, by the first controller, the previously stored first shared key ID using the random number received from the second controller;
based on the verification of the previously stored first shared key ID being successful, generating, by the first controller, an encrypted message and transmitting the encrypted message to the second controller; and
decrypting and verifying, by the second controller, the encrypted message using the previously stored second shared key ID.

17. The method of claim 12, wherein the verifying of the validity of the previously stored first shared key ID comprises:
based on a difference between a value of the previously stored second shared key ID and a value of the previously stored first shared key ID being less than a reference value, determining, by the second controller, that the validity of the previously stored first shared key ID has been verified, and updating and storing the value of the previously stored second shared key ID using the value of the previously stored first shared key ID.

18. The method of claim 12, wherein the verifying of the validity of the previously stored first shared key ID comprises
based on a difference between a value of the previously stored second shared key ID and a value of the previously stored first shared key ID being greater than or equal to a reference value, determining, by the second controller, that the validity of the previously stored first shared key ID has not been verified and outputting a verification error signal.

19. The method of claim 18, further comprising:
based on authentication of the identity consecutively fails for a preset number of times or more during a preset time period, causing the second controller to activate a protection mode and stop a key authentication process.

20. The method of claim 19, further comprising:
based on receiving a protection mode release signal from a diagnostic device, determining, by the second controller, whether a digital key is located inside the vehicle and releasing the protection mode.
